(19) United States
(12) Patent Application Publication
(10) Pub. No.: US 2018/0174760 A1
(43) Pub. Date: Jun. 21, 2018

(54) CAPACITOR

(71) Applicant: Murata Manufacturing Co., Ltd., Nagaokakyo-shi (JP)

(72) Inventors: KAZUO HATTORI, Nagaokakyo-shi (JP); Noriyuki Inoue, Nagaokakyo-shi (JP)

(21) Appl. No.: 15/846,626

(22) Filed: Dec. 19, 2017

Related U.S. Application Data
(63) Continuation of application No. PCT/JP2016/067126, filed on Jun. 8, 2016.

(30) Foreign Application Priority Data
Jul. 10, 2015 (JP) 2015-138953

(51) Int. Cl. H01G 9/045; H01G 9/15; H01G 9/07; H01G 9/055; H01G 4/012; H01G 4/33; H01G 4/12; H01G 4/08; H01G 9/012

(52) U.S. Cl. CPC H01G 9/045; H01G 9/15; H01G 9/07; H01G 9/055; H01G 9/012; H01G 4/33; H01G 4/12; H01G 4/085; H01G 4/012

(57) ABSTRACT

A capacitor includes a first electrode formed from a conductive porous base material, a dielectric layer located on the first electrode and a second electrode located on the dielectric layer. The first electrode is electrically connected to first and second terminal electrodes located on respective opposite ends of the first electrode. The second electrode is located between the first and second terminal electrodes and is electrically connected to a third terminal electrode located on the second electrode.

### CROSS REFERENCE TO RELATED APPLICATIONS

The present application is a continuation of International application No. PCT/JP2016/067126, filed Jun. 8, 2016, which claims priority to Japanese Patent Application No. 2015-138953, filed Jul. 10, 2015, the entire contents of each of which are incorporated herein by reference.

### TECHNICAL FIELD

The present invention relates to a capacitor.

### BACKGROUND ART

In recent years, with higher-density mounting of electronic devices, smaller-sized capacitors with higher electrostatic capacitance have been required. In addition, for the suppression of high-frequency ripple noises associated with increased power supply operation frequencies of electronic devices, capacitors have been required which are lower in equivalent series resistance (ESR: Equivalent Series Resistance). Therefore, there has been a growing demand for capacitors which are small in size, high in electrostatic capacitance, and low in ESR. As such a capacitor which is low in ESR and high in electrostatic capacitance in a small size, the chip-type solid electrolytic capacitor described in Japanese Patent Application Laid-Open No. 2005-57105 is known.

According to Japanese Patent Application Laid-Open No. 2005-57105, the formation of an oxide film at the surface of an anode composed of a valve-action metal and the use of a conductive polymer at the cathode side achieve high electrostatic capacitance and low ESR. However, the thus configured capacitor has polarity leading to restrictions on the use the capacitor since there is a possibility of causing short circuits in the circuit to which a reverse voltage is applied (for example, a circuit to which a negative bias voltage or an alternating-current voltage with reference to 0 V is applied). More specifically, it is difficult to achieve capacitors without any polarity while achieving a balance between high electrostatic capacitance in a small size and low ESR.

An object of the present invention is to provide a capacitor without any polarity while achieving a balance between high electrostatic capacitance in a small size and low ESR.

### BRIEF DESCRIPTION OF THE INVENTION

The inventors have unexpectedly found, as a result of earnestly carrying out studies in order to solve the problem mentioned above, that a capacitor without any polarity can be provided while achieving a balance between high electrostatic capacitance in a small size and low ESR, by forming a dielectric layer on a first electrode formed of conductive porous base material, forming an upper electrode thereon on top of the dielectric layer and connecting the first electrode formed of the conductive porous base material and the upper electrode to respective terminal electrodes.

According to a first aspect of the present invention, a capacitor is provided which is characterized in that the capacitor includes:

a first electrode formed from a conductive porous base material;

a dielectric layer located on the first electrode; and

a second electrode located on the dielectric layer,

first and second terminal electrodes electrically connected to the first terminal electrode and located on respective opposite ends of the first electrode; and

the second electrode being located between the first and second terminal electrodes and electrically connected to a third terminal electrode located on the second electrode.

According to a second aspect of the present invention, an electronic component is provided which includes the capacitor according to the present invention, and the first terminal electrode and the second terminal electrode of the capacitor are connected as a negative electrode.

According to the present invention, the formation of the dielectric layer on the conductive porous base material (that is, the first electrode) and the formation of the upper electrode (that is, the second electrode) thereon can provide a capacitor without any polarity while achieving a balance between high electrostatic capacitance and low ESR.

### BRIEF EXPLANATION OF DRAWINGS

FIG. 1 is a schematic perspective view of a capacitor 1a according to an embodiment of the present invention.

FIG. 2 is a schematic cross-sectional view along the line x-x of the capacitor 1a shown in FIG. 1.

FIG. 3 is a schematic perspective view of a capacitor 1b according to another embodiment of the present invention.

FIG. 4 is a schematic cross-sectional view of the capacitor 1b shown in FIG. 3 along the line y-y.

FIGS. 5(a)-5(i) are schematic cross-sectional views for explaining the manufacture of a capacitor according to Example 1.

FIG. 6 represents is a process flow diagram for explaining the manufacture of the capacitor according to Example 1.

FIG. 7 is a cross-sectional view schematically illustrating a porous structure of the capacitor according to Example 1.

FIG. 8 is a schematic cross-sectional view illustrating a capacitor according to Example 2 mounted on a substrate.

FIGS. 9(a)-9(i) are schematic cross-sectional views for explaining the manufacture of a capacitor according to Example 3.

### DESCRIPTION OF THE PREFERRED EMBODIMENTS

A capacitor according to the present invention will be described in detail below with reference to the drawings. However, the capacitor according to the present embodiment, and the shapes and arrangement of respective constructional elements are not limited to the examples shown in the figures.

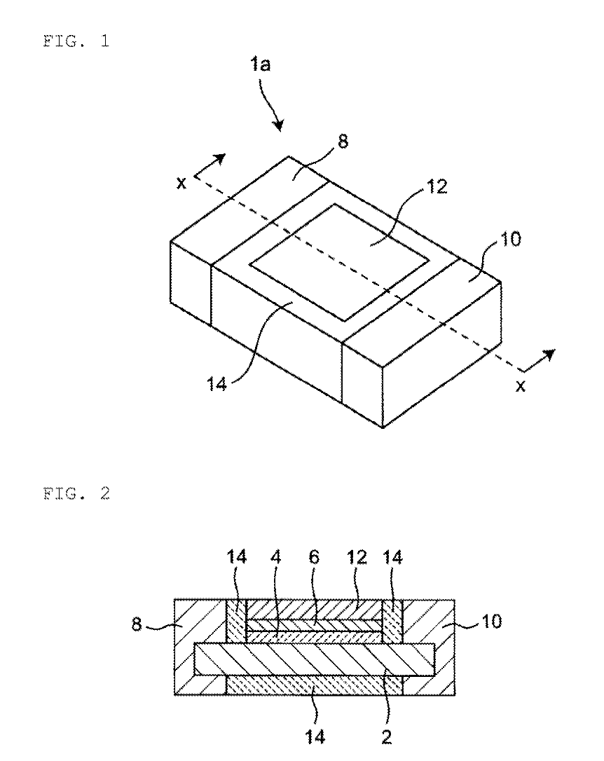

FIG. 1 is a schematic perspective view of a capacitor 1a according to an embodiment of the present invention, and FIG. 2 shows a schematic cross-sectional view thereof. The capacitor 1a according to the present embodiment has, as shown in FIGS. 1 and 2, a substantially cuboid shape, and schematically has a first electrode 2 formed from a conductive porous base material, a dielectric layer 4 located on the first electrode 2, and a second electrode 6 located on the dielectric layer 4. The first electrode 2 is, at each end thereof, electrically connected to a first terminal electrode 8 and a second terminal electrode 10. The second electrode 6 is located between the first and second terminal electrodes 8 and 10. In addition, the second electrode 6 is electrically connected to a third terminal electrode 12 located on the second electrode 6. The second electrode 6 and the third terminal electrode 12 are electrically isolated from the first and second terminal electrodes 8 and 10 by an insulating part 14. The first and second terminal electrodes 8 and 10 are physically isolated by the insulating part 14, but are electrically connected by the first electrode 2. The first and second electrodes 2 and 6 are located at positions opposed to each other with the dielectric layer 4 interposed therebetween. Electric charges can be accumulated in the dielectric layer 4 by applying a voltage between the first and second electrodes 2 and 6.

FIG. 3 shows a schematic perspective view of a capacitor 1b according to another embodiment of the present invention and FIG. 4 shows a schematic cross-sectional view thereof. The capacitor 1b according to this embodiment has a substantially cuboid shape and schematically has a first electrode 22, formed from a conductive porous base material, a dielectric layer 24 located on the first electrode 22, and a second electrode 26 located on the dielectric layer 24. Opposite ends of the first electrode 22 are electrically connected to first and second terminal electrodes 28 and 30, respectively. The second electrode 26 is located between the first and second terminal electrodes 28 and 30 but is electrically isolated therefrom. However, the second electrode 26 is electrically connected to a third terminal electrode 32 located on the second electrode 26. The dielectric layer 24, the second electrode 26, and the third terminal electrode 32 are formed in a cylindrical shape so as to surround the circumference of the first electrode 22. The first electrode 22 extends completely through the cylindrical dielectric layer 24, the cylindrical second electrode 26, and the cylindrical third terminal electrode 32. The second electrode 26 and the third terminal electrode 32 are electrically isolated from the first terminal electrode 28 by an insulating part 34 are electrically isolated from the second terminal electrode 30 by an insulating part 36. The first electrode 22 has, at opposite ends thereof (right and left ends in FIG. 4), low-porosity parts 42 with a high-porosity part 44 located therebetween. The capacitor 1b serves as a so-called feed-through capacitor.

The material and configuration of the conductive porous base material constituting the first electrode in each of the foregoing embodiments are not limited as long as the conductive porous base material has a conductive surface. For example, the conductive porous base material may be a porous metal base material formed from a conductive metal, or a non-conductive material, for example, a porous silica material, a porous carbon material, or a porous ceramic sintered body having a conductive layer formed on the surface thereof. The use of the porous base material can increase the surface area of the first electrode in contact with the dielectric layer and thus achieve higher electrostatic capacitance. In accordance with a preferred aspect, the conductive porous base material is a porous metal base material.

Examples of the metal constituting the porous metal base material mentioned above include, for example, metals of aluminum, tantalum, nickel, copper, titanium, niobium, and iron, and alloys such as stainless steel and duralumin. Preferably, the conductive metal base material is an aluminum porous base material.

The conductive porous base material mentioned above may have one or two (or more) porous principal surfaces. In addition, there are no particular limitations on the locations, disposition number, sizes, shapes, and the like of porous parts. In accordance with a preferred aspect, the conductive porous base material has a high-porosity part and a low-porosity part (relative to one another).

The porosity in the high-porosity part can be preferably 20% or more, more preferably 30% or more, further preferably 50% or more, and more preferably 60% or more. The increased porosity can further increase the electrostatic capacitance of the capacitor. In addition, from the perspective of increasing the mechanical strength, the porosity of the high-porosity part can be preferably 90% or less, more preferably 80% or less.

In this specification, the term “porosity” refers to the proportion of voids in the porous part. The porosity can be measured as follows.

A sample for TEM (Transmission Electron Microscope) observation of the porous part is prepared by an FIB (Focused Ion Beam) micro-sampling method. A cross section of the sample is observed at approximately 50,000-fold magnification, and subjected to measurement by STEM (Scanning Transmission Electron Microscopy)-EDS (Energy Dispersive X-ray Spectrometry) mapping analysis. The ratio of an area without any base material present in the mapping measurement field is regarded as the porosity.

The high-porosity part is not particularly limited, but preferably has an expanded surface ratio of 30 times or more and 10,000 times or less, more preferably 50 times or more to 5,000 times or less, for example, 300 times or more and 600 times or less. In this regard, the expanded surface ratio refers to the surface area per unit projected area. The surface area per unit projected area can be obtained from the amount of nitrogen adsorption at a liquid nitrogen temperature with the use of a BET specific surface area measurement system.

The low-porosity part refers to a region that is lower in porosity than the high-porosity part. It is to be noted that there is no need for the low-porosity part to have any pores. The porosity of the low-porosity part is, from the perspective of increasing the mechanical strength, preferably a porosity that is 60% or less of the porosity of the high-porosity part, and more preferably a porosity that is 50% or less of the porosity of the high-porosity part. For example, the porosity of the low-porosity part is preferably 20% or less, and more preferably 10% or less. In addition, the low-porosity part may have a porosity of 0%. The low-porosity part makes a contribution to an improvement in the mechanical strength of the capacitor.

It is to be noted that the conductive porous base material (first electrode 22) of the capacitor 1b according to the present embodiment has the low-porosity parts 42, which are not essential elements. In addition, even in the case of providing low-porosity parts, the locations, disposition numbers, sizes, shapes, and the like of the parts are not particularly limited.

In the capacitor according to the present embodiment, the dielectric layer is formed on the first electrode. The shape of the dielectric layer is not particularly limited, but can be various shapes for any purpose. For example, as in the capacitor 1a, the dielectric layer 4 may be formed on one surface of the first electrode 2. Preferably, as in the capacitor 1b, the dielectric layer 24 may be formed in a cylindrical shape so as to surround the circumference of the first electrode 22. It is to be noted that the “cylindrical shape” refers to a shape with a through hole, and there are no limitations on the size and shape of the through hole, the thickness and shape of a wall that defines the through hole, and the like. For example, the dielectric layer formed in the cylindrical shape in the capacitor 1b is a layer formed thinly so as to surround the porous metal base material following the surface shape (that is, porous shape) of the porous metal base material (first electrode). In this case, the through hole defined by the dielectric layer corresponds to a part associated with the presence of the porous metal base material surrounded by the dielectric layer. The adoption of such a shape can achieve higher electrostatic capacitance, and also further reduce noises because of ESR reduced.

The material that forms the dielectric layer mentioned above is not particularly limited as long as the material has an insulating property, but examples thereof preferably include metal oxides such as AlOx (e.g., Al2O3), SiOx (e.g., SiO2), AlTiOx, SiTiOx, HfOx, TaOx, ZrOx, HfSiOx, ZrSiOx, TiZrOx, TiZrWOx, TiOx, SrTiOx, PbTiOx, BaTiOx, BaSrTiOx, BaCaTiOx, and SiAlOx; metal nitrides such as AlNx, SiNx, and AlScNx; or metal oxynitrides such as AlOxNy, SiOxNy, HfSiOxNy, and SiCxOyNz. As the material that forms the dielectric layer, AlOx, SiOx, SiOxNy, and HfSiOx are preferred, and AlOx (typically, Al2O3) is more preferred. It is to be noted that the formulas mentioned above are merely intended to represent the constitutions of the materials, but not intended to limit the compositions. More specifically, the x, y, and z attached to O and N may have any value larger than 0, and the respective elements including the metal elements may have any presence proportion.

The thickness of the dielectric layer mentioned above is not particularly limited, but for example, preferably 5 nm or more and 100 nm or less, more preferably 10 nm or more and 50 nm or less. The dielectric layer of 5 nm or more in thickness can increase the insulating property, and thus reduce leakage current. In addition, the dielectric layer of 100 nm or less in thickness can achieve higher electrostatic capacitance.

The dielectric layer mentioned above is preferably formed by a gas-phase method, for example, a vacuum vapor deposition method, a chemical vapor deposition (CVD: Chemical Vapor Deposition) method, a sputtering method, an atomic layer deposition (ALD: Atomic Layer Deposition) method, a pulsed laser deposition method (PLD: Pulsed Laser Deposition), or the like. In particular, when the base material is a porous base material, the CVD method or the ALD method is more preferred, and the ALD method is particularly preferred, because the methods can form more homogeneous and denser films even in microscopic regions of pores. This use of the gas-phase method, in particular, the ALD method can further increase the insulating property of the dielectric layer, and further increase the electrostatic capacitance of the capacitor.

In the capacitors 1a and 1b according to the present embodiments, the second electrodes (upper electrodes) are formed on the dielectric layers mentioned above.

The materials constituting the second electrodes mentioned above are not particularly limited as long as the material has a conductive property, but examples of the material include Ni, Cu, Al, W, Ti, Ag, Au, Pt, Zn, Sn, Pb, Fe, Cr, Mo, Ru, Pd, and Ta and alloys thereof, e.g., CuNi, AuNi, AuSn, metal nitrides and metal oxynitrides such as TiN, TiAlN, TiON, TiAlON, TaN, and electrically conductive polymers (for example, PEDOT (poly(3,4-ethylenedioxythiophene)), polypyrrole, polyaniline), and TiN or TiON is preferred, and TiN is more preferred.

The thickness of the second electrode is not particularly limited, but, by way of example, is preferably 3 nm or more, and more preferably is 10 nm or more. The second electrode of 3 nm or more in thickness can reduce the resistance of the second electrode itself.

The second electrode can be formed, but not particularly limited thereto, for example, by a method such as an ALD method, a chemical vapor deposition (CVD: Chemical Vapor Deposition) method, plating, bias sputtering, a Sol-Gel method, or electrically conductive polymer filling. When the base material is a porous base material, the second electrode is preferably formed by the ALD method, because the method can form more homogeneous and denser films even in microscopic regions of pores.

In accordance with an aspect, when the base material is a porous base material, a conductive film may be formed by the ALD method, and pores may be filled thereon by the ALD method or another approach, with a conductive substance, preferably a substance that is lower in electrical resistance. This constitution can efficiently achieve a higher electrostatic capacitance density and a lower ESR.

In the capacitors 1a and 1b according to the foregoing embodiments, the first terminal electrode and the second terminal electrode are respectively formed on opposite ends of the first electrode and the third terminal electrode is formed on the second electrode.

The materials constituting the foregoing terminal electrodes are not particularly limited, but examples of the materials include, for example, metals such as Ag, Pd, Ni, Cu, Sn, Au, and Pb, and alloys thereof. The materials constituting the first terminal electrodes, the second terminal electrodes, and the third terminal electrodes may be the same material or different materials. The method for forming the terminal electrodes is not particularly limited, but for example, electrolytic plating, electroless plating, a CVD method, vapor deposition, sputtering, conductive paste baking, and the like can be used, and electrolytic plating or electroless plating is preferred.

In the capacitors 1a and 1b according to the foregoing embodiments, the insulating parts are formed on the first electrodes so as to isolate the second electrode and the third terminal electrode from the first and second terminal electrodes.

The materials constituting the insulating parts are not particularly limited as long as the materials have an insulating property, but can be insulating inorganic materials, for example, insulating ceramics or glass, or insulating organic materials, for example, resins.

The method for forming the insulating parts is not particularly limited, but dispensers, plating, laminate, CVD methods, vapor deposition, sputtering, screen printing, ink-jet printing, and the like can be used.

The capacitor according to the present invention is high in electrostatic capacitance and low in ESR in spite of having no polarity. In addition, the adoption of a three-terminal structure and/or a feed-through structure can reduce noises.

While the capacitor according to the present invention has been described above with reference to the capacitors 1a and 1b according to the embodiments described above, the present invention is not to be considered limited to the specific capacitors described, but various modifications can be made thereto.

For example, the capacitor according to the present invention may have layers other than the layers present in the foregoing embodiments. Such layers may, for example, be located between the respective layers, e.g., between the first electrode and the dielectric layer, or between the dielectric layer and the second electrode.

In addition, the first electrode, the first terminal electrode, and the second terminal electrode are formed separately in the foregoing embodiments, but the invention is not limited to this aspect, and for example, may be formed integrally from a conductive base material. In other words, the first electrode may also serve as the first terminal electrode and the second terminal electrode. Likewise, the second electrode and the third terminal electrode are formed separately in the foregoing embodiments, but the invention is not limited to this aspect, and the electrodes may be formed integrally. In other words, the second electrode may also serve as the third terminal electrode.

As mentioned above, the capacitor according to the present invention has no polarity with the result that the first electrode (composed of aluminum or the like) can be connected to a negative electrode side. Therefore, there is no need to check the polarity in connecting the capacitor according to the present invention to an electronic component of a circuit, thereby simplifying the mounting operation. In addition, problems such as capacitor failures and short circuits due to mounting with polarity reversed are also never caused. Especially, in the case of feed-through structure, a through electrode is wired such that a direct-current power supply line passes completely through to the other side, whereas the other electrode is wired to the ground, thereby making it possible to suppress noises superimposed on the power supply line in an effective manner. In particular, the capacitor according to the present invention is also allowed to be used in the application of noise suppression in a negative power-supply line that generates a negative direct-current voltage.

Therefore, the present invention also provides an electronic component, for example, a circuit board characterized in that it includes the capacitor, and the first terminal electrode and the second terminal electrode of the capacitor are connected as a negative electrode.

### EXAMPLES

### Example 1

A method for manufacturing a first example capacitor in accordance to an embodiment (Example 1) of the invention will now be described.

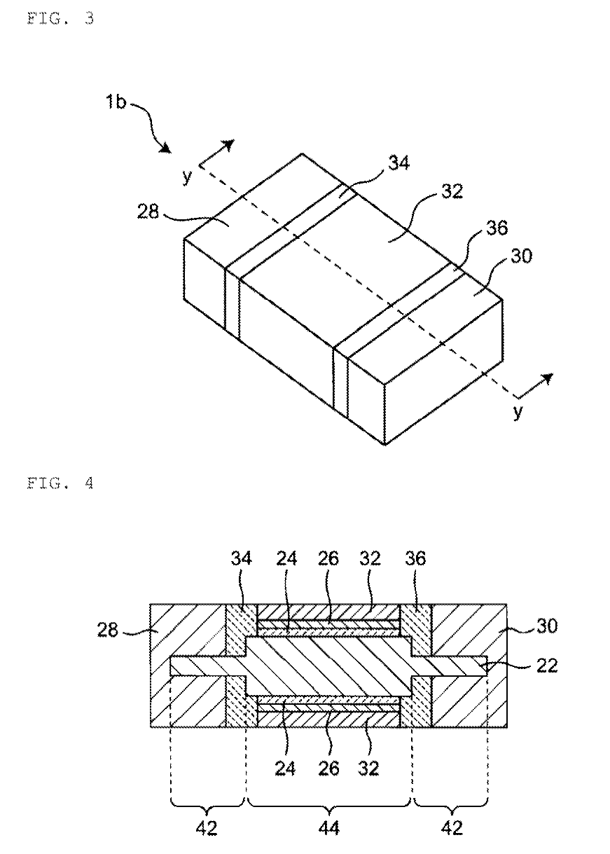

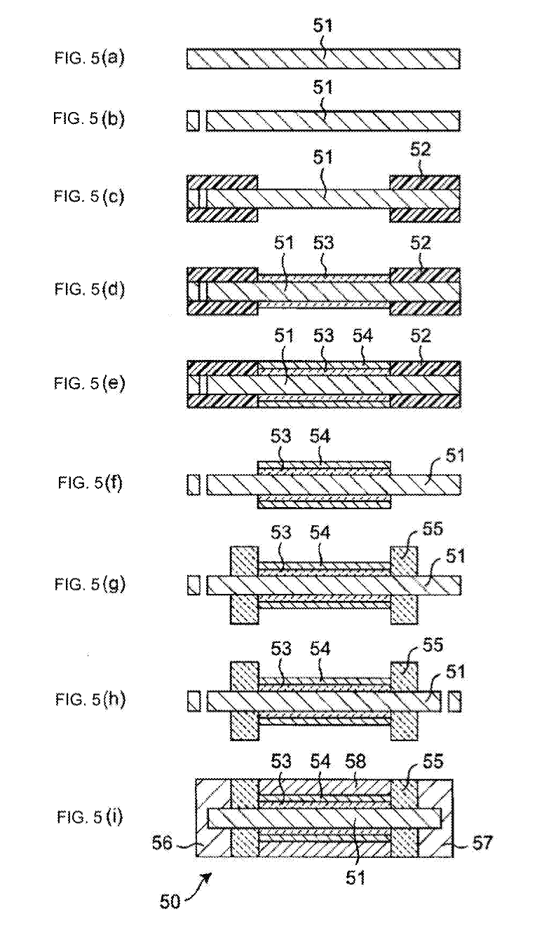

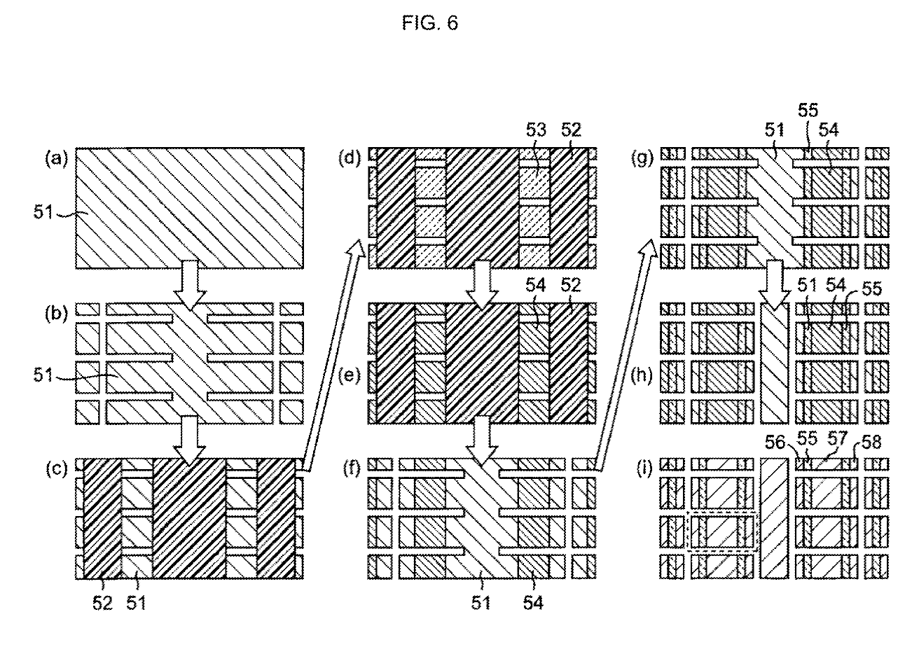

Aluminum etching foil 51 of 100 μm in thickness with pores at both main surfaces was prepared as a conductive substrate (FIG. 5(a) and FIG. 6, Step (a)). Next, the aluminum etching foil 51 was cut with a laser, with a bar left (FIG. 5(b) and FIG. 6, Step (b)).

Next, on the aluminum etching foil 51, a polyimide resin was applied by screen printing, thereby forming a mask (FIG. 5(c) and FIG. 6, Step (c)).

Next, an AlOx layer 53 as a dielectric layer 20 nm in thickness was formed around the surfaces of the etching foil S3 by an ALD method to be (FIG. 5(d) and FIG. 6, Step (d)). Next, a TiN layer 54 as a second electrode was formed around the outer surface of the dielectric layer by an ALD method (FIG. 5(e) and FIG. 6, Step (e)). It is to be noted that an AlOx layer and a TiN layer were also formed on the mask, but are not shown in the figures for the sake of simplicity.

Next, the mask 52 was removed (FIG. 5(f) and FIG. 6, Step (f)), and an insulating part 55 of SiO2 was formed by a CVD method (FIG. 5(g) and FIG. 6, Step (g)).

Finally, the bar was cut with a laser, for cutting into respective elements (FIG. 5(h) and FIG. 6, Step (h)), and a first terminal electrode 56, a second terminal electrode 57, and a third terminal electrode 58 were formed by copper plating (FIG. 5(i) and FIG. 6, Step (i)), thereby manufacturing a capacitor 50 according to Example 1.

It is to be noted that the porous structure is omitted in FIGS. 5 and 6 for the sake of simplicity. The porous structure is schematically illustrated in FIG. 7.

Polarity Test

The breakdown voltage of the first example capacitor (Example 1) was measured with the capacitor connected as stated in the following (A) and (B). Specifically, a direct-current voltage was applied while gradually increasing the voltage, and the voltage at the time when the value of current flowing through the capacitor exceeded 1 mA was regarded as the breakdown voltage.

(A) The first and second terminal electrodes, and along with them the first electrode (aluminum etching foil), were connected to a positive electrode and the third terminal electrode in continuity with the second electrode (the TiN layer) were connected to ground.

(B) The first and second terminal electrodes were connected to ground, in continuity with the first terminal electrode (aluminum etching foil), and the third terminal electrode (in continuity with the second electrode (TiN layer)) was connected to a positive electrode.

For each of (A) and (B), ten samples were subjected to the measurement, and the average value for the samples was obtained, which was, as a result, 6.4 V in each case. More specifically, it has been confirmed that the capacitors according to Example 1 have no polarity.

### Example 2

A capacitor 60 according to Example 2 was prepared in the same way as in Example 1, except for forming a first terminal electrode, a second terminal electrode, and a third terminal electrode by copper plating, and thereafter, carrying out nickel plating 61 thereon, and then tin plating 62.

The obtained capacitor 60 was mounted onto a substrate 65 by connecting the first and second terminal electrodes 56 and 57, in continuity with the first electrode (aluminum etching foil) S1, to a negative electrode 63 and connecting the third terminal electrode 58, in continuity with the second electrode (TiN layer) 54, to a positive electrode 64 with the use of a joining material 66 (FIG. 8). The application of a voltage to the sample according to Example 2 has confirmed that the sample functions normally.

### Example 3

A method for manufacturing a third example capacitor will now be described.

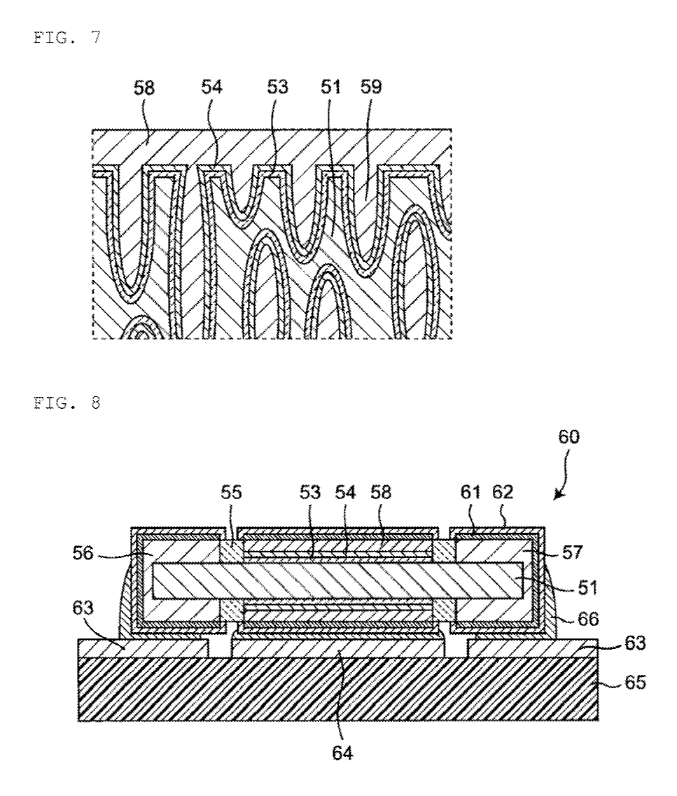

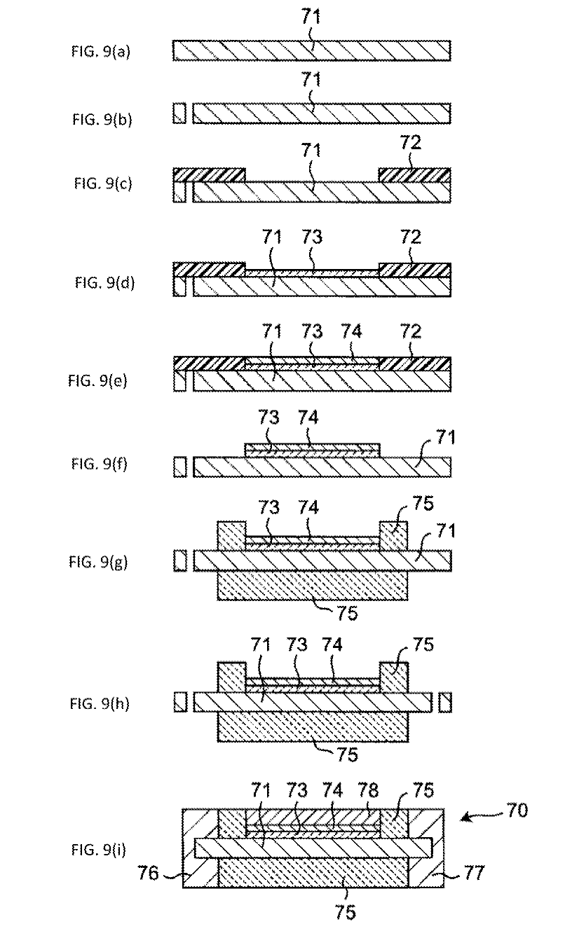

Aluminum etching foil 71 of 70 μm in thickness with pores at one surface was prepared as a conductive substrate (FIG. 9(a)). Next, the aluminum etching foil was cut with a laser, with a bar left (FIG. 9(b)).

Next, on the aluminum etching foil 71, a polyimide resin was applied by screen printing, thereby forming a mask (FIG. 9(c)).

Next, an AlOx layer 73 as a dielectric layer was formed entirely by an ALD method to be 20 nm in thickness (FIG. 9(d)). Next, a TiN layer 74 as a second electrode was formed entirely by an ALD method (FIG. 9(e)). It is to be noted that an AlOx layer and a TiN layer were also formed on the mask, but are not shown in the figures for the sake of simplicity.

Next, the mask 72 was removed (FIG. 9(f)), and an insulating part 75 of SiO2 was formed by a CVD method (FIG. 9(g)).

Finally, the bar was cut with a laser, for cutting into respective elements (FIG. 9(h)), and a first terminal electrode 76, a second terminal electrode 77, and a third terminal electrode 78 were formed by copper plating (FIG. 9(i)), thereby manufacturing a capacitor 70 according to Example 3.

Polarity Test

The breakdown voltage of the capacitor 70 of Example 3 was measured with the capacitor connected as described in the following (A) and (B) as in the case of Example 1. Specifically, a direct-current voltage was applied while gradually increasing the voltage, and the voltage at the time when the value of current flowing through the sample exceeded 1 mA was regarded as the breakdown voltage.

(A) The first and second terminal electrodes, along with the first electrode (the aluminum etching foil), were connected to a positive electrode and the third terminal electrode along with second electrode (TiN layer), was connected to ground.

(B) The first and second terminal electrodes, along with the first electrode (the aluminum etching foil), were connected to ground and the third terminal electrode, along with the second electrode (the TiN layer), was connected to a positive electrode.

For each of (A) and (B), ten samples were subjected to the measurement, and the average value for the samples was obtained, which was, as a result, 6.4 V in each case. More specifically, it has been confirmed that the capacitors according to Example 3 have no polarity.

The capacitor according to the present invention is high in electrostatic capacitance and low in ESR without any polarity, and thus used for various electronic devices in a preferred manner.

### DESCRIPTION OF REFERENCE SYMBOLS

1a, 1b: capacitor
2: first electrode
4: dielectric layer
6: second electrode
8: first terminal electrode
10: second terminal electrode
12: third terminal electrode
14: insulating part
16: insulating part
18: insulating part
22: first electrode
24: dielectric layer
26: second electrode
28: first terminal electrode
30: second terminal electrode
32: third terminal electrode
34: insulating part
36: insulating part
42: low-porosity part
44: high-porosity part
50: capacitor
51: aluminum etching foil
52: mask
53: AlOx layer
54: TiN layer
55: insulating part
56: first terminal electrode
57: second terminal electrode
58: third terminal electrode
59: pore
60: capacitor
61: Ni plating
62: Sn plating
63: negative electrode
64: positive electrode
65: substrate
70: capacitor
71: aluminum etching foil
72: mask
73: AlOx layer
74: TiN layer
75: insulating part
76: first terminal electrode
77: second terminal electrode
78: third terminal electrode

1. A capacitor comprising:
a first electrode formed from a conductive porous base material;
a dielectric layer located on the first electrode;
a second electrode located on the dielectric layer;
first and second terminal electrodes electrically connected to the first electrode and located on respective opposite ends of the first electrode; and
the second electrode being located between the first and second terminal electrodes and electrically connected to a third terminal electrode located on the second electrode.

2. The capacitor according to claim 1, wherein the capacitor is a feed-through capacitor in which the dielectric layer and the second electrode are formed in a cylindrical shape around the first electrode, and the first electrode is electrically connected, through the dielectric layer and the second electrode, to the first and second terminal electrodes.

3. The capacitor according to claim 2, wherein:
the conductive porous base material comprises a high-porosity part and a low-porosity part;
the dielectric layer and the second electrode are formed on the high-porosity part; and
the first terminal electrode and the second terminal electrode are formed on the low-porosity part.

4. The capacitor according to claim 3, wherein the conductive base material is an aluminum base material.

5. The capacitor according to claim 4, wherein the dielectric layer is formed by an atomic layer deposition method.

6. The capacitor according to claim 5, wherein the upper electrode is formed by an atomic layer deposition method.

7. An electronic component comprising the capacitor according to claim 6, wherein the first terminal electrode and the second terminal electrode of the capacitor are connected as a negative electrode.

8. The capacitor according to claim 1, wherein:
the conductive porous base material comprises a high-porosity part and a low-porosity part;
the dielectric layer and the second electrode are formed on the high-porosity part; and
the first terminal electrode and the second terminal electrode are formed on the low-porosity part.

9. The capacitor according to claim 8, wherein the conductive base material is an aluminum base material.

10. The capacitor according to claim 9, wherein the dielectric layer is formed by an atomic layer deposition method.

11. The capacitor according to claim 10, wherein the upper electrode is formed by an atomic layer deposition method.

12. An electronic component comprising the capacitor according to claim 11, wherein the first terminal electrode and the second terminal electrode of the capacitor are connected as a negative electrode.
